(19) United States
(12) Patent Application Publication
(10) Pub. No.: US 2021/0025447 A1
(43) Pub. Date: Jan. 28, 2021

(54) BEARING PACKAGE

(71) Applicant: NTN Corporation, Osaka (JP)

(72) Inventor: Takashi YAMAMOTO, Mie (JP)

(73) Assignee: NTN Corporation, Osaka (JP)

(21) Appl. No.: 16/980,105

(22) PCT Filed: Mar. 11, 2019
(86) PCT No.: PCT/JP2019/009683

§ 371 Date: Sep. 11, 2020

(30) Foreign Application Priority Data
Mar. 14, 2018 (JP) 2018-046477

(51) Int. Cl. F16C 23/08; F16C 19/38

(52) U.S. Cl. CPC F16C 23/08; F16C 19/383

(57) ABSTRACT

A bearing package is provided which includes a rolling bearing, a first packaging member wrapped around the rolling bearing over the entire circumference thereof, a first annular elastic member, and a second annular elastic member. The first elastic member and the second elastic member are disposed on both axial sides of at least one row of rolling elements. The first elastic member and the second elastic member are pushed by the first packaging member so as to restrict axial movement of the at least one row of rolling elements.

### TECHNICAL FIELD

The present invention relates to a bearing package including a packaging member in which a rolling bearing is packaged.

### BACKGROUND ART

In a conventional general method of packaging a rolling bearing, a rolling bearing is placed and scaled in a hag (below-identified Patent Document 1).

It is also generally known to wrap an antirust tape around a rolling bearing over the entire circumference thereof.

### PRIOR ART DOCUMENT(S)

### Patent Document(s)

Patent document 1: Japanese Unexamined Patent Application Publication No. 2012-250747

### SUMMARY OF THE INVENTION

### Problems to be Solved by the Invention

However, vibrations and/or shocks are repeatedly applied to such a bearing package while being transported in a truck on rough roads over a long distance.

In a bearing package as disclosed in Patent Document 1 in which a rolling bearing is sealed in, e.g., a bag, and received in a container, if vibrations and/or shocks are applied to the bearing package while being transported, the rolling elements vibrate relative to the raceway surfaces. Especially if vibrations and/or shocks are repeatedly applied to the bearing package, such as while being transported in a truck on rough roads over a long distance, fretting may occur on the rolling elements and the raceway surfaces.

In view of the above background, it is an object of the present invention to provide a bearing package which is, capable of preventing fretting between the rolling elements and each of the inner and outer rings due to shocks and/or vibrations applied to the bearing package while being transported.

### Means for Solving the Problems

In order to achieve the above object, the present invention provides a bearing package comprising: a rolling bearing including an inner ring, an outer ring, and at least one row of rolling elements disposed between the inner ring and the outer ring; a first packaging member wrapped around the rolling bearing over an entire circumference of the rolling, bearing; a first elastic member having an annular shape, and disposed on a first axial side of first and second opposite axial sides of the at least one row of rolling elements, the first and second opposite axial sides corresponding, respectively, to sides in first and second axial directions which are opposite to each other, the first elastic member being located between the at least one row of rolling elements and the first packaging member; and a second elastic member having an annular shape, and disposed on a second axial side of the first and second opposite axial sides of the at least one row of rolling elements so as to be located between the at least one row of rolling elements and the first packaging member, wherein the first elastic member and the second elastic member are pushed toward the at least one row of rolling elements by the first packaging member so as to restrict axial movement of the at least one row of rolling elements.

With this arrangement, when wrapping the first packaging member around the entire circumference of the rolling bearing, it is possible to push the first and second annular elastic members toward the at least one row of rolling elements by pressing the first and second elastic members with the first packaging member. The pushing forces of the first packaging member are transmitted from both axial directions to the at least one row of rolling elements through the first and second elastic members, thereby restricting axial movement of the rolling elements. With the axial movement of the rolling element restricted, even if shocks and/or vibrations are applied to the bearing package while being transported, the first and second elastic members prevent vibrations of the rolling elements, and thus prevent fretting between the rolling elements and each of the inner and outer rings.

For example, the inner ring may have a first end surface and a second end surface which define a width of the inner ring; a first outer peripheral end portion located on the first axial side of the at least one row of rolling elements; and a second outer peripheral end portion located on the second axial side of the at least, one row of rolling elements. The outer ring may have a third end surface and a fourth end surface which define a width of the outer ring. The first elastic member may be shaped to be radially supported by the first outer peripheral end portion of the inner ring, and to partially protrude beyond the first end surface of the inner ring and the third end surface of the outer ring, in the first axial direction. The second elastic member may be shaped to be radially supported by the second outer peripheral end portion of the inner ring, and to partially protrude beyond the second end surface of the inner ring and the fourth end surface of the outer ring, in the second axial direction. With this arrangement, because the first and second elastic members are stabilized by the first and second outer peripheral end portions, when wrapping the first packaging member around the rolling bearing, the first packaging member can be reliably pressed against the protruding portions of the first and second elastic members protruding out of the inner and outer rings in the width direction thereof.

As a specific example, the rolling elements may be rollers. The first outer peripheral end portion of the inner ring may be a radially outer surface of a flange configured to receive the first axial side of the rolling elements. The second outer peripheral end portion of the inner ring may be a radially outer surface of a flange configured to receive the second axial side of the rolling elements. With this, arrangement, it is possible to stabilize the first and second elastic members by using the flanges, of the inner ring.

It is necessary to wrap the first packaging member around the rolling bearing so as to rover the first and second elastic members. If a packaging machine is used to wrap the first packaging member, it is necessary to provide some measures to prevent the first and second elastic members from falling off spontaneously from the first and second outer peripheral end portions, respectively, before the rolling bearing is placed on the packaging machine. Also, it is required to make it difficult for the first and second elastic members to separate from the first and second outer peripheral end portions of the inner ring, respectively.

It is therefore preferable that the first outer peripheral end portion of the inner ring has a first groove extending continuously around an entire circumference of the first outer, peripheral end portion, and the, first elastic member includes a radially inner portion located within the first groove, and that the second outer peripheral end portion of the inner ring has a second groove extending continuously around an entire circumference of the second outer peripheral end portion, and the second elastic member includes a radially inner portion located within the second groove. With this arrangement, i.e., by locating the radially inner portions of the first and second elastic members within the first and second grooves, respectively, if the first and second elastic members are about to separate from the first and second grooves, respectively, the first and second elastic members will be stretched in the circumferential direction, and pressed hard against the first and second grooves with these stretching forces. Therefore, without the need to temporarily fix the first and second elastic members with a separate member or members, it is possible to prevent the first and second elastic members from falling off spontaneously during packaging, and also to prevent the first and second elastic members from separating from the first and second outer peripheral end portions of the inner ring, respectively, while the bearing package is being transported.

It is more preferable that each of the first groove and the second groove has a circular arc-shaped cross section, that each of the first elastic member and the second elastic member is a circular annular member having a circular cross section, and continuously extending around an entire circumference, that the first groove has a sectional radius larger than a sectional radius of the first elastic member, and the second groove has a sectional radius larger than a sectional radius of the second elastic member, that, in a non-packaged state in which the radially inner portion of the first elastic member and the radially inner portion of the second elastic member are located within the first groove and the second groove, respectively, and in which the first packaging member has not yet been wrapped around the rolling bearing, a widthwise center of the first groove is axially offset from a sectional center of the first elastic member toward a widthwise center of the inner ring by a first offset amount C, and a widthwise center of the second groove is axially offset from a sectional center of the second elastic member toward the widthwise center of the inner ring by a second offset amount C, and that a relationship between the first offset amount C and a first compressed amount B by which the first elastic member is compressed by the first packaging member from the non-packed state is set to satisfy C≥B, and a relationship between the second offset amount C and a second compressed amount B by which the second elastic member is compressed by the first packaging member from the non-packed state is set to satisfy C≥B. With this arrangement, during packaging, the first and second elastic members are axially pushed toward the widthwise center of the inner ring, while sliding on the respective grooves toward the widthwise centers thereof, by the first packaging member, so that the first and second elastic members are reliably compressed by the first and second compressed amounts B, respectively. Therefore, once the first packaging member has been wrapped around the rolling bearing, each of the first and second elastic members can uniformly generate an axial pushing force over the entire circumference thereof.

In the present invention, the first packaging member may be either directly or indirectly wrapped around the rolling bearing.

For example, the bearing package may further comprise a second packaging member enclosing the rolling bearing in the second packaging member. The second packaging member may include recessed portions recessed, between the inner ring and the outer ring, toward an interior of the rolling bearing until the second packaging member comes into contact with the rolling elements. The first elastic member and the second elastic member may be disposed between the first packaging member and the respective recessed portions of the second packaging member. With this arrangement, the pushing force of the first packaging member can be transmitted to the rolling elements through the first and second elastic members and the recessed portions of the second packaging member. Also, the second packaging member prevents any fragments that may be produced from the first elastic member and/or the second elastic member from entering the bearing.

The present invention can be applied is both a single-row bearing and a double-row bearing.

As an example of a double-row bearing to which the present invention is applied, the bearing package may further comprise a cage keeping circumferential distances between the at least one row of rolling elements. The at least one row of rolling elements may comprise a first row of rolling elements disposed on a first axial side of first and second opposite axial sides of the cage, the first and second opposite axial sides of the cage corresponding, respectively, to sides in the first and second axial directions, and a second row of rolling elements disposed on a second axial side of the first and second opposite axial sides of the cage. The first elastic member and the second elastic member may be pushed by the first packaging member, and press, respectively, the first row of rolling elements and the second row of rolling elements against the cage. With this arrangement, it is possible to restrict axial movement of the two (first and second) rows of rolling elements by pressing the two rows of rolling elements against the cage from both axial directions with the first and second elastic members, which is being pushed by the first packaging member. Therefore, it is possible to prevent fretting in the bearing package including such a double-row bearing.

As a specific example, the rolling bearing may be a self-aligning roller bearing.

### Effects of the Invention

In the bearing package of the present invention, which has the above structure, no fretting occurs between the rolling elements and each of the inner and outer rings due to shocks and/or vibrations applied to the bearing package while being transported.

### BRIEF DESCRIPTION OF THE DRAWINGS

FIG. 1 is a sectional view of a bearing package according to a first embodiment of the present invention taken along line I-I of FIG. 4.

FIG. 2 is a partially enlarged side view of the bearing package of FIG. 1.

FIG. 3 is a partially enlarged side view of an intermediate package right before packed with the first packaging member of FIG. 1.

FIG. 4 is a partial perspective view of an inner ring assembly of the rolling bearing illustrated in FIG. 1.

FIG. 5 is a sectional view of a bearing package according to a second embodiment of the present invention.

FIG. 6 is a partially enlarged side view of the bearing package of FIG. 5.

FIG. 7 is a sectional view of an intermediate package right before packed with the first packaging member of FIG. 5.

FIG. 8 is a partially enlarged side view of the intermediate package of FIG. 7.

FIG. 9 is a sectional view of a bearing package according to a third embodiment of the present invention.

### BEST MODE FOR CARRYING OUT THE INVENTION

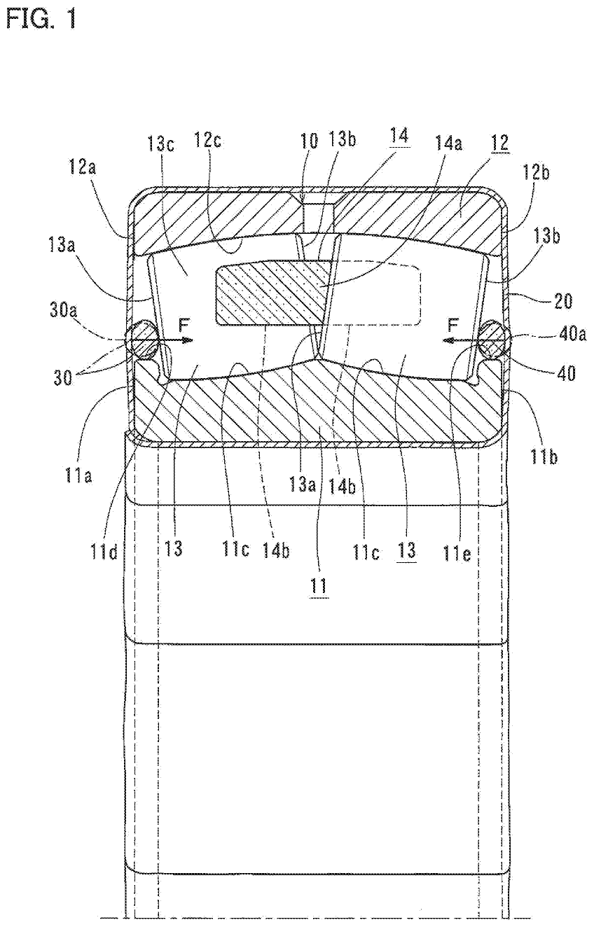

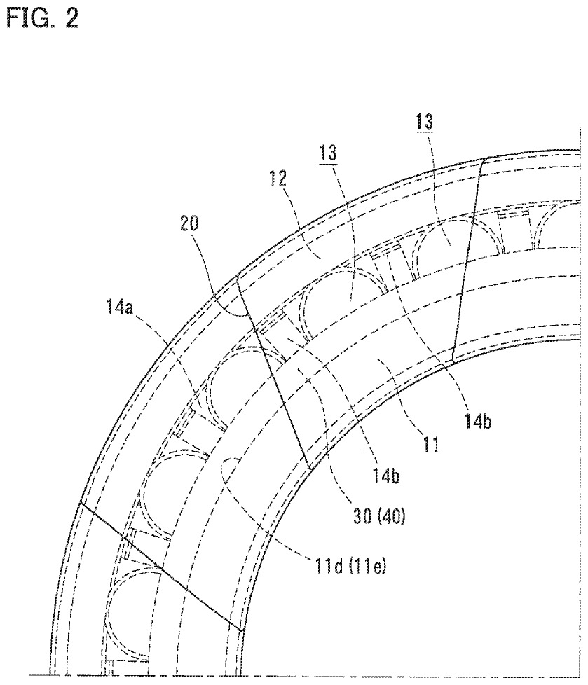

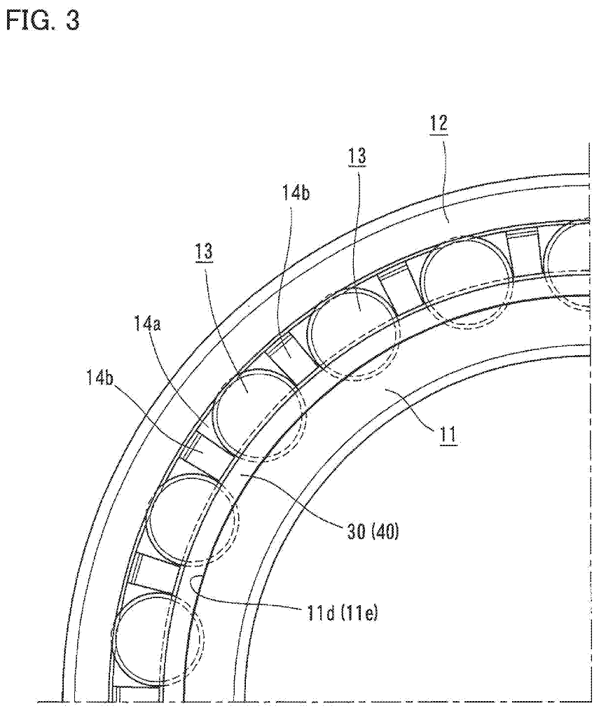

The bearing package according to the first embodiment of the present invention is now described with reference to FIGS. 1 to 4. As illustrated in FIGS. 1 and 2, the bearing package includes a roiling bearing 10, a first packaging member 20, a first elastic member 30, and a second elastic member 40. FIG. 3 is a side view illustrating a state in which the first packaging member 20 has not yet been wrapped around the rolling bearing 10.

As used herein, “axial”, “axially”, and “axial direction” refer to the direction along the center axis (on blueprint; not shown) of the rolling bearing 10; “one axial direction/side” and “the other axial direction/side” refer to one and the other of the two opposite axial directions/sides, respectively; “radial”, “radially” and “radial direction” refer to a direction orthogonal to the center axis of the rolling bearing; and “circumferential”, “circumferentially” and “circumferential direction” refer to the circumferential direction about the center axis of the rolling bearing.

As illustrated in FIG. 1, the rolling bearing 10 includes an inner ring 11; an outer ring 12; at least one row of rolling elements 13 disposed between the inner ring 11 and, the outer ring 12; and a cage 14.

In the example shown, the rolling bearing 10 is a self-aligning roller bearing including two rows of rolling elements 13.

The inner ring 11 and the outer ring 12 are each constituted by a single part. The inner ring 11, the outer ring 12, and the rolling elements 13 are made of a metallic material such as a bearing steel.

The inner ring 11 has a first end surface 11a defining one end of the width of the inner ring 11; a second end surface 11b opposite from the first end surface 11a, and defining the other end of the width of the inner ring 11, two rows of raceway surfaces 11c; a first outer peripheral end portion lid located on the one axial side (left side in FIG. 1) of the two rows of rolling elements 13; and a second outer peripheral end portion lie located on the other axial side (right side in FIG. 1) of the two rows of rolling element 13.

The outer ring 12 has a third end surface 12a defining one end of the width of the outer ring 12; a fourth end surface 12b opposite from the third end surface 12a, and defining the other end of the width of the outer ring 12; and a raceway surface 12c which is a spherical surface.

The widths of the inner and outer rings 11 and 12 are equal to each other.

The rolling elements 13 are disposed between the raceway surfaces 11c of the inner ring 11 and the raceway surface 12c of the outer ring 12. The rolling elem fits 13 are rollers. More specifically, the rolling elements 13 are spherical rollers each having an end surface 13a on the one axial side (left side in FIG. 1) thereof; an end surface 13b on the other axial side (right side in FIG. 1) thereof; and a convex rolling surface 13c.

The first outer peripheral end portion 11d of the inner ring 11 is a radially outer surface of a flange configured to receive the one axial side (left side in FIG. 1) of the rolling elements 13. The second outer peripheral end portion lie of the inner ring 11 is a radially outer surface of a flange configured to receive the other axial side (right side in FIG. 1) of the rolling elements 13. The first and second outer peripheral end portions 11d and 11e are cylindrical surfaces.

The cage 14 keeps circumferential distances between the at least one row of rolling elements 13. The cage 14 is a machined cage constituted by a single integral component. In the example shown, the cage 14 includes an annular portion 14a: first pillars 14b protruding in the one axial direction from the annular portion 14a; and second pillars 14b protruding in the other axial direction from the annular portion 14a.

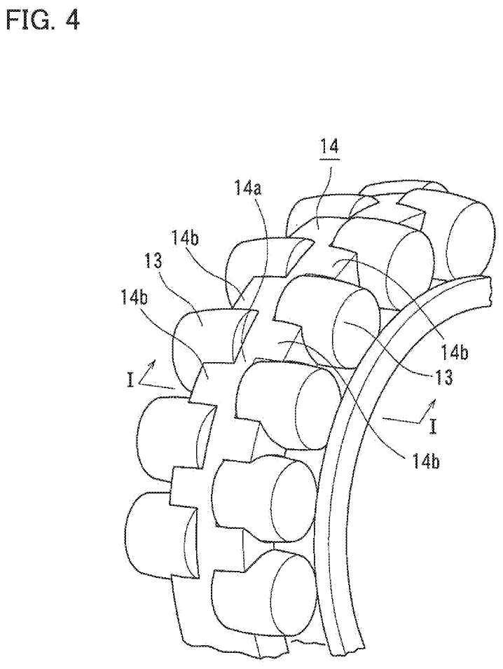

Further in the example shown, the at least one row of rolling elements comprises two rows of rolling elements 13, i.e., a first row of rolling elements 13 disposed on the one axial side (left side in FIG. 4) of the annular portion 14a of the cage 14 and between the first pillars 14b, and a second row of rolling elements 13 disposed on the other axial side (right side in FIG. 4) of the annular portion 14a and between the second pillars 14b. As illustrated in FIG. 4, an inner ring assembly is constituted by the cage 14, the two rows of rolling elements 13, and the inner ring 11. Each first pillar 14b (on the left side in FIG. 4) is circumferentially displaced from any of the second pillars 14b (on the right side in FIG. 4).

The end surfaces 13a of the first row (left row in FIG. 4) of rolling elements 13 are located on the one axial side (left side in FIG. 4) of the first pillars 14b (i.e., the pillars on the one axial side of the annular portion 14a or left side in FIG. 4) , and also located on the other axial side (right side in FIG. 1) of the first end surface 11a of the inner ring 11 and the third end surface 12a of the outer ring 12. The end surfaces 13b of the second row (right row in FIG. 4) of rolling elements 12 are located on the other axial side (right side in FIG. 4) of the second pillars 14b (i.e., the pillars located on the other axial side of the annular portion 14a or right side in FIG. 4), and also located on the one axial side (left side in FIG. 1) of the second end surface 11b of the inner ring 11 and the fourth end surface 12b of the outer ring 12.

The rolling bearing 10 is an open bearing, i.e., a bearing including neither seals nor shields between the inner ring 11 and the outer ring 12.

As illustrated in FIG. 2, the first packaging member 20 is wrapped around the rolling bearing 10 over the entire circumference thereof. The first packaging member 20 is, e.g., a tape made of synthetic resin. The tape-shaped first packaging member 20 can be wrapped around the rolling bearing 10 using a conventional automatic wrapping machine used to wrap antirust tapes around bearings.

Each of the first and second elastic members 30 and 40 illustrated in FIG. 1 is an annular rubber member such as an O-ring.

The first elastic member 30 is disposed on the one axial side (left side in FIG. 1) of the first and second rows of rolling elements 13 and between the first row of rolling elements 13 and the first packaging member 20. The second elastic member 40 is disposed on the other axial side (right side in FIG. 1) of the first and second rows of rolling elements 13 and between the second row of rolling elements 13 and the first packaging member 20.

As illustrated in FIG. 3, with the first packaging member 20 not yet wrapped around the rolling bearing 10, the first elastic member 30 is fitted to the first outer peripheral end portion 11d of the inner ring 11, and the second elastic member 40 is fitted to the second outer peripheral end portion 11e of the inner ring 11. The inner diameters of the first and second elastic members 30 and 40 are determined such that the first and second elastic members 30 and 40 are fitted, respectively, to the first and second outer peripheral end portions 11d and 11e of the inner ring 11 with interference, i.e., with a slight tightening force due to the interference. In this way, the first elastic member 30 and the second elastic member 40 are shaped to be radially supported by the first outer peripheral end portion 11d and the second outer peripheral end portion 11e, respectively.

The cross-sectional contours of the first and second elastic members 30 and 40 in the state of FIG. 3 are shown by one-dot chain lines in FIG. 1. As is apparent from these one-dot chain lines, the first elastic member 30 is shaped to have a protruding portion 30a protruding in the one axial direction (left direction in FIG. 1) beyond the first end surface 11a of the inner ring 11 and the third end surface 12a of the outer ring 12, and the second elastic member 40 is shaped to have a protruding portion 40a protruding in the other axial direction (right direction in FIG. 1) beyond the second end surface 11b of the inner ring 11 and the fourth end surface 12b of the outer ring 12. Therefore, when wrapping the first packaging member 20 around the rolling bearing over the entire circumference thereof as illustrated in FIGS. 1 and 2, the first packaging member 20 presses against the protruding portions 30a and 40a of the first and second elastic members 30 and 40, which protrude out of the inner and outer rings 11 and 12 in the width direction thereof, thereby pushing the first and second elastic members 30 and 40 toward the two rows of rolling elements 13. In other words, by pressing against the protruding portion 30a, the first packaging member 20 pushes the first elastic member 30 toward the rolling elements 13, and by pressing against the protruding portion 40a, the first packaging member 20 pushes the second elastic member 40 toward the rolling elements 13.

The first row (left row in. FIG. 1) of rolling elements 13 illustrated in FIG. 1 are pressed against the annular portion 14a of the cage 14 with a pushing force F by the first elastic member 30, which is pushed in the other axial direction (right direction in FIG. 1) by the first packaging member 20. Therefore, the first row (left row in FIG. 1) of rolling elements 13 are in contact with the first elastic member 30 at their end surfaces 13a, and are in contact with the annular portion 14a at their end surfaces 13b. The second row (right row in FIG. 1) of rolling elements 13 illustrated in FIG. 1 are pressed against the annular portion 14a of the cage 14 with a pushing force F by the second elastic member 40, which is pushed in the one axial direction (left direction in FIG. 1) by the first packaging member 20. Therefore, the second row (right row in FIG. 1) of rolling elements 13 are in contact with the second elastic member 40 at their end surfaces 13b, and are in contact with the annular portion 14a at their end surfaces 13a. Since the first and second elastic members 30 and 40, which are pushed by the first packaging member 20, press, from the opposite axial directions, the two rows of rolling elements 13 against the annular portion 14a of the cage 14 with the pushing forces F, the axial movement of the two rows of rolling elements 13 is restricted. With the rolling elements pressed against the cage, the protruding portions 30a and 40a of the first and second elastic members 30 and 40 act as axial interference which causes compressive deformation of the first and second elastic members 30 and 40. As a result, the first and second elastic members 30 and 40 push the respective rows of rolling elements 13, while producing elastic repulsive forces.

In this bearing package, when wrapping the first packaging member 20 around the rolling bearing 10 over the entire circumference thereof, the first packaging member 20 presses against and pushes the first and second annular elastic members 30 and 40 toward the respective rows of rolling elements 13. Thus, the pushing forces F from the first packaging member 20 are transmitted from both axial directions to the respective rows of rolling elements 13 through the first and second elastic members 30 and 40 such that the rolling elements 13 are pressed against the annular portion 14a of the cage 14, so that the axial movement of the two rows of rolling elements 13 is restricted by the first and second elastic members 30 and 40, which are being pushed by the first packaging member 20. With the axial movement of the rolling elements restricted, even if shocks and/or vibrations are applied to the bearing package while being transported, the first and second elastic members 30 and 40 prevent vibrations of the rolling elements 13, and thus prevent fretting between the rolling elements 13 and each of the inner and outer rings 11 and 12. In other words, it is possible to prevent fretting between the rolling elements 13 and each of the inner and outer rings 11 and 12 due to shocks and/or vibrations applied to the bearing packaging arrangement during transportation.

Also, in this bearing package, because the first and second elastic members 30 and 40 are stabilized by the first and second outer peripheral end portions 11d and 11e of the inner ring 11, when wrapping the first packaging member 20 around the rolling bearing 10, the first packaging member 20 can be reliably pressed against the protruding portions 30a and 40a of the elastic members 30 and 40 which protrude out of the inner and outer rings in the width direction thereof. Therefore, it is possible to reliably restrict axial movement of the rolling elements 13 with the elastic repulsive forces produced by the first and second elastic members 30 and 40.

Also, in this bearing package, it is possible to stabilize the first and second elastic members 30 and 40 by using the flanges of the inner ring 11 as the first and second outer peripheral end portions 11d and 11e.

Also, in this bearing package, it is possible to restrict axial movement of the two rows of rolling elements 13 by pressing the two rows of rolling elements 13 against the cage 14 from both axial directions with the first and second elastic members 30 and 40, which is pushed by the first packaging member 20. Therefore, it is possible to prevent fretting in the bearing package including such a double-row bearing.

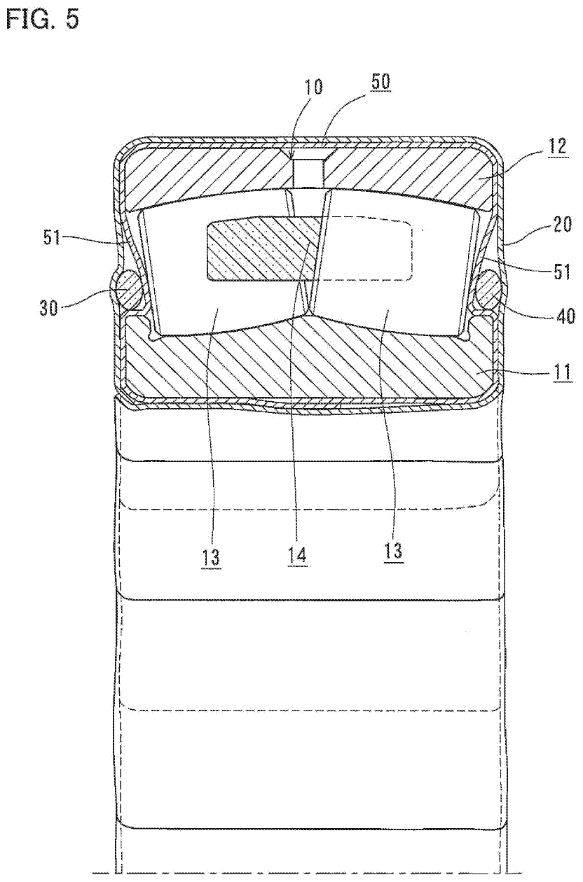

The bearing package according to the second embodiment of the present invention is now described with reference to FIGS. 5 to 8. Only the features of the second embodiment different from those of the first embodiment are described below, and the same element names are used with respect to the elements of the second embodiment, common to those of the first embodiment.

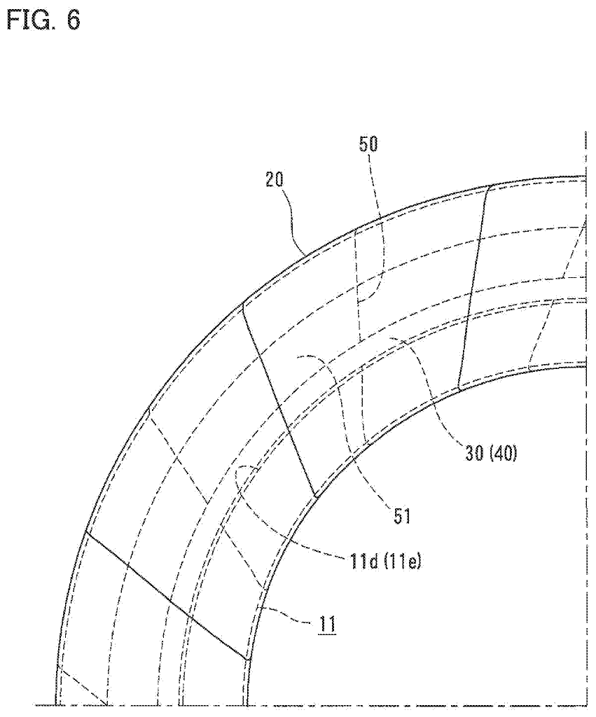

As illustrated in FIGS. 5 and 6, the bearing package of the second embodiment further includes a second packaging member 50 disposed inside of the first packaging member 20 and enclosing the rolling bearing 10 therein.

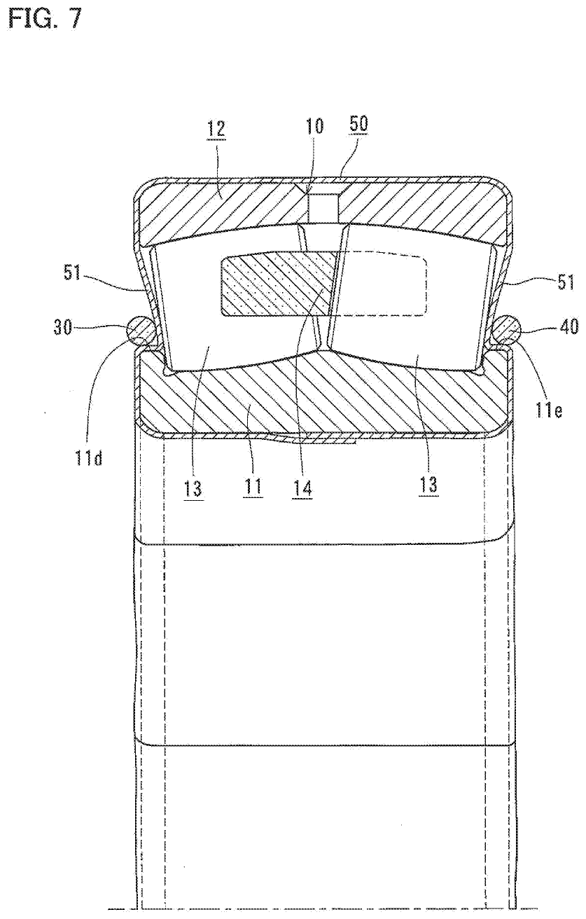

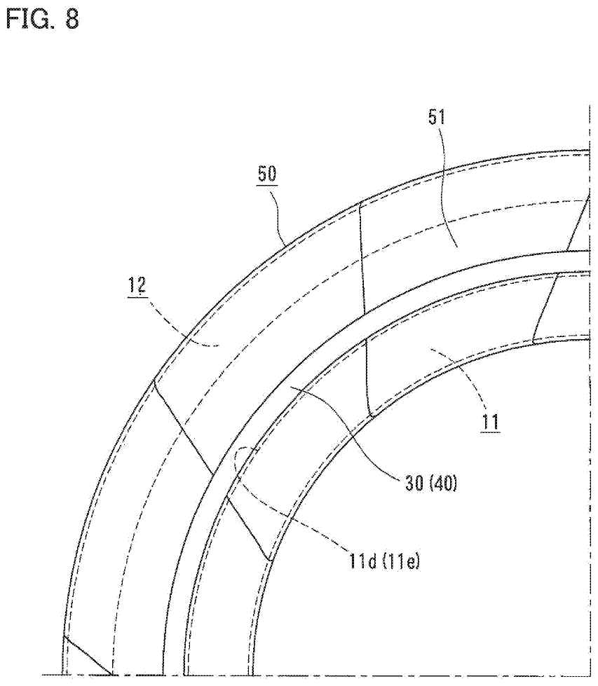

As illustrated in FIGS. 7 and 8, the second packaging member 50 is wrapped art end the rolling bearing 10 over the entire circumference thereof before wrapping the first packaging member 20. The second packaging member 50 is, e.g., a tape made of synthetic resin.

The second packaging member 50 includes recessed portions 51 recessed, between the inner and outer rings 11 and 12, toward the interior of the bearing until the second packaging member 50 comes into contact with the rolling elements 13. The recessed portions 51 of the second packaging member 50 are formed, for example, by redundantly wrapping the second packaging member 50 so as to be partially superposed on the first and second outer peripheral end portions 11d and 11e of the inner ring 11.

The first and second elastic members 3 and 40 are fitted, respectively, to the portions of the second packaging member 50 superposed on the first and second outer peripheral end portions 11d and 11e of the inner ring 11. Thus, the first and second elastic embers 30 and 40 are radially supported, respectively, by the first and second outer peripheral end portions 11d and 11e of the inner ring 11 via the second packaging member 50.

As illustrated in FIGS. 5 and 6, the first packaging member 20 is indirectly wrapped around the rolling bearing 10 so as to enclose in the first packaging member, e,g., the second packaging member 50 disposed as illustrated in FIGS. 7 and 8. Thus, as illustrated in FIGS. 5 and 6, the first elastic member 30 and the second elastic member 40 are disposed between the first packaging member 20 and the respective recessed portions 51 of the second packaging member 50.

In this bearing package, the first elastic member 30 and the second elastic member 40 are disposed between the first packaging member 20 and the respective recessed portions 51 of the second packaging member 50, which are recessed, between the inner and outer rings 11 and 12 toward, the interior of the bearing until the second packaging member 50 comes into contact with the rolling elements 13. Therefore, the pushing force of the first packaging member 20 can be transmitted to the rolling elements 13 through the first and second elastic members 30 and 40 and the recessed portions 51 of the second packaging member 50. The second packaging member 50 prevents any fragments that may be produced from the first elastic member 30 and/or the second elastic member 40 from entering the bearing as foreign matter.

Since the second packaging member is used for the purpose of preventing entry of foreign matter as described above, the second packaging member does not need to be stretched with enough tension to be able to push the first and second elastic members, and is required only to be capable of enclosing the rolling bearing before does the first packaging member. For example, the second packaging member may be a bag. If the second packaging member is wrapped around the rolling bearing prior to the first packaging member, the second packaging member may be: (i) continuous with, and made of the same material as, the first packaging member; (ii) not continuous with, but made of the same material as, the first packaging member; (iii) not continuous with, and made of a different material from, the first packaging member; or (iv) constituted by an antirust tape.

Since neither of the first elastic member and the second elastic member is rubbed against hard and sharp parts, of other members, it is considered to be quite rare that fragments are produced from the first elastic member 30 and/or the second elastic member 40 even during transportation. Therefore, it is usually preferable to use the first embodiment, of which the packaging cost is relatively low. However, especially if it is required to reliably prevent entry of foreign matter into the bearing, it is preferable to use the second embodiment.

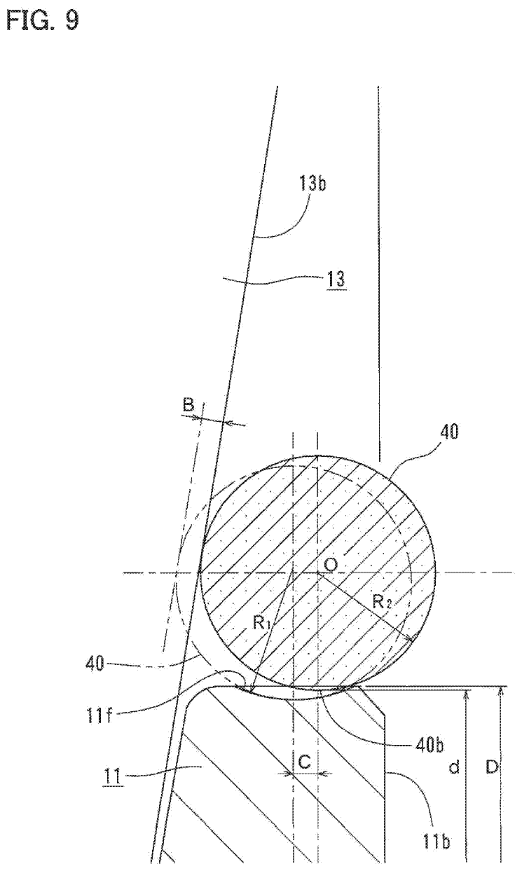

The bearing package according to the third embodiment of the present invention is now described with. reference to FIG. 9. The third embodiment is different from the first embodiment in that grooves are formed in the first and second outer peripheral end portions of the inner ring 11, respectively, such that the first packaging member can be wrapped around the bearing with the first and second elastic members fitted in the respective grooves. FIG. 9 illustrates the second outer peripheral end portion of the inner ring and its vicinity in the non-packaged state in which the first packaging member has not yet been wrapped around the rolling bearing, and, only the relationship between the second outer peripheral end portion of the inner ring 11 and the second elastic member 40 is described below. The relationship between the first outer peripheral end portion of the inner ring and the first elastic member is simply symmetrical to the above relationship shown in FIG. 9, and thus is neither described nor shown.

As illustrated in FIG. 9, the groove 11f in the second outer peripheral end portion of the inner ring 11 extends continuously around the entire circumference thereof. Further, the groove 11f has a circular arc-shaped cross section and has a radial depth from the radially outer surface of the flange. The sectional radius R1 of the groove 11f corresponds to the radius of curvature of the circular arc-shaped cross section. The groove 11f, has the shown sectional shape on any axial plane.

Since the second elastic member 40 is an O-ring as described above, the second elastic member 40 is a circular annular member having a circular cross section, and continuously extending around the entire circumference.

FIG. 9 shows, by solid line, a fitted state of the second elastic member 40 in which the second elastic member is fitted in the groove 11f while being in contact with, but not being pressed against, the end surfaces 13b of the corresponding row of rolling elements. The second elastic member 40 has the shown sectional shape on any axial plane. The second elastic member 40 shown by the solid line is hereinafter referred to a “the second elastic member 40 in the fitted state”.

The second elastic member 40 in the fitted state includes a radially inner portion 40b located within the groove 11f. The second elastic member 40 in the fitted state has an inner diameter d smaller than the outer diameter D of the second outer peripheral end portion of the inner ring 11 (corresponding to the outer diameter of the flange, and thus to the diameter of the shoulders of the groove 11f). Therefore, the second elastic member 40 in the fitted state is slightly stretched in the circumferential direction compared to the shape of the second elastic member 40 when formed as an O-ring, and is pressed against the groove 11f by this stretching force.

The sectional radius R₂ of the second elastic member 40 in the fitted state corresponds to the length of a straight line radially extending from the sectional center O of the second elastic member 40 in the fitted state to the surface thereof. The sectional radius R₁ of the groove 11f is larger than the sectional radius R₂ of the second elastic member 40 in the fitted state. The widthwise center of the groove 11f is axially offset from the sectional center O of the second elastic member 40 in the fitted state toward the widthwise center of the inner ring (toward the left side in FIG. 9) by an offset amount C. When, in the state of FIG. 9, the first packaging member is wrapped around the rolling bearing in the same manner as in FIG. 1, the protruding portion of the second elastic member 40 in the fitted state protruding beyond the second end surface 11b of the inner ring 11 is pushed toward the left side in FIG. 9, so that the second elastic member 40 moves smoothly on the groove 11f (having a relatively large sectional radius R₁) toward the left side in FIG. 9, and comes into contact with the widthwise center of the groove 11f.

The two-dot chain line in FIG. 9 shows the second elastic member 40 in this (imaginary) position. The second elastic member 40 in the imaginary position is in contact with the widthwise center of the groove 11f, while maintaining the shape of the second elastic member 40 in the fitted state. The compressed amount B by which the second elastic member 40 in the fitted state is compressed by the first packaging member is given by the distance between the end surfaces 13b of the rolling elements 13 and the imaginary straight line extending parallel to the end surfaces 13b and constituted by the tangent line in contact with the cross-section of the second elastic member 40 in the imaginary position from the side of the widthwise center of the inner ring. The relationship between the compressed amount B and the above-mentioned offset amount C is set to satisfy C≥B.

If the second elastic member 40 in the fitted state is about to separate from the groove 11, the second elastic member 40 will be stretched in the circumferential direction, and will be pressed hard against the groove 11f with the stretching force. Therefore, without the need to temporarily fix the second elastic member 40 with a separate member, it is possible to prevent the second elastic member 40 from falling off spontaneously during packaging. Also, once the, bearing package is complete by wrapping the first packaging member in the same manner as in FIG. 1, the second elastic member 40 is deformed into an elliptical shape, and contacts the widthwise center of the groove 11f, so that if the second elastic ember 40 is about to separate from the groove 11f, in this state, the elastic member 40 will be stretched in the circumferential direction. Therefore, it is also possible to prevent separation of the second elastic member 40 from the second outer peripheral end portion of the inner ring during transportation. These preventive effects can be obtained in the first elastic member which is not shown in FIG. 9, too.

Also, when the rolling bearing is packed, the second elastic member 40 is axially pushed and slid toward the widthwise center of the inner ring (toward the left side in FIG. 1) by the first packaging member until the second elastic member 40 is reliably compressed by the compressed amount B. Therefore, after the first packaging member is wrapped around the rolling bearing as illustrated in FIG. 1, the second elastic member 40 can uniformly generate an axially pushing force over the entire circumference thereof. This uniform pushing force can be generated by the first elastic member which is not shown in FIG. 9, too.

The present invention can be applied to any rolling bearing in which the first and second elastic members can be disposed between the first packaging member and the rolling elements. Therefore, the present invention can be applied to not only a bearing package including an inseparable type of bearing such as a self-aligning roller bearing, but also a bearing package including a separable type of bearing such as a tapered roller bearing or a cylindrical roller bearing.

Also, the present invention can be also applied to a single-row bearing including only one row of rolling elements. If the present invention is applied to a single-row bearing, it is possible to restrict axial movement of the rolling elements by simply pushing both sides of the rolling elements with the first and second elastic members.

Also, if the present invention is applied to a bearing including a cage the cage may have any shape, e.g., may be a basket type of cage, provided that gaps are defined between the cage and the respective raceway surfaces so as to transmit the pushing forces of the first packaging member to the rolling elements through the first and second elastic members.

Also, if the present invention is applied to a double-row bearing including an intermediate flange or a flange ring formed in one of the inner and outer rings the rolling elements may be pushed against the intermediate flange or the flange ring instead of pushing the rolling elements against the cage as in the embodiments.

Also, each of the inner and outer rings may be constituted by a plurality of parts, e.g., two raceway members tightened by tightening members.

The above-described embodiments are mere examples in every respect, and the present invention is not limited thereto. The scope of the present invention is indicated by the claims, and should be understood to include all modifications within the scope and the meaning equivalent to the scope of the claims.

### DESCRIPTION OF REFERENCE NUMERALS

10: Rolling bearing
11: Inner ring
11a: First end surface
11b: Second end surface
11d: First outer peripheral end portion
11e: Second outer peripheral end portion
11f: Groove
12: Outer ring
12a: Third end surface
12d: Fourth end surface
13: Rolling element
14: Cage
14a: Annular portion
20: First packaging member
30: First elastic member
40: Second elastic member
50: Second packaging member
51: recessed portion

1. A bearing package comprising:
a rolling bearing including an inner ring, an outer ring, and at least one row of rolling elements disposed between the inner ring and the outer ring;
a first packaging member wrapped around the rolling bearing over an entire circumference of the rolling bearing;
a first elastic member having an annular shape, and disposed on a first axial side of first and second opposite axial sides of the at least one row of rolling elements, the first and second opposite axial sides corresponding, respectively, to sides in first and second axial directions which are opposite to each other, the first elastic member being located between the at least one row of rolling elements and the first packaging member; and
a second elastic member having an annular shape, and disposed on a second axial side of the first and second opposite axial sides of the at least one row of rolling elements so as to be located between the at least one row of rolling elements and the first packaging member,
wherein the first elastic member and the second elastic member are pushed toward the at least one row of rolling elements by the first packaging member so as to restrict axial movement of the at least one row of rolling elements.

2. The bearing package according to claim 1, wherein the inner ring has:
a first end surface and a second end surface which define a width of the inner ring;
a first outer peripheral end portion located on the first axial side of the at least one row of rolling elements; and
a second outer peripheral end portion located on the second axial side of the at least one row of rolling elements,
wherein the outer ring has a third end surface and a fourth end surface which define a width of the outer ring,
wherein the first elastic member is shaped to be radially supported by the first outer peripheral end portion of the inner ring, and to partially protrude beyond the first end surface of the inner ring and the third end surface of the outer ring, in the first axial direction, and
wherein the second elastic member is shaped to be radially supported by the second outer peripheral end portion of the inner ring, and to partially protrude beyond the second end surface of the inner ring and the fourth end surface of the outer ring, in the second axial direction.

3. The bearing package according to claim 2, wherein the rolling elements are rollers,
wherein the first outer peripheral end portion of the inner ring is a radially outer surface of a flange configured to receive the first axial side of the rolling elements, and
wherein the second outer peripheral end portion of the inner ring is a radially outer surface of a flange configured to receive the second axial side of the rolling elements.

4. The bearing package according to claim 3, wherein the first outer peripheral end portion of the inner ring has a first groove extending continuously around an entire circumference of the first outer peripheral end portion, and the first elastic member includes a radially inner portion located within the first groove, and
wherein the second outer peripheral end portion of the inner ring has a second groove extending continuously around an entire circumference of the second outer peripheral end portion, and the second elastic member includes a radially inner portion located within the second groove.

5. The bearing package according to claim 4, wherein each of the first groove and the second groove has a circular arc-shaped cross section,
wherein each of the first elastic member and the second elastic member is a circular annular member having a circular cross section, and continuously extending around an entire circumference,
wherein the first groove has a sectional radius larger than a sectional radius of the first elastic member, and the second groove has a sectional radius larger than a sectional radius of the second elastic member,
wherein, in a non-packaged state in which the radially inner portion of the first elastic member and the radially inner portion of the second elastic member are located within the first groove and the second groove, respectively, and in which the first packaging member has not yet been wrapped around the rolling bearing, a widthwise center of the first groove is axially offset from a sectional center of the first elastic member toward a widthwise center of the inner ring by a first offset amount C, and a widthwise center of the second groove is axially offset from a sectional center of the second elastic member toward the widthwise center of the inner ring by a second offset amount C, and
wherein a relationship between the first offset amount C and a first compressed amount B by which the first elastic member is compressed by the first packaging member from the non-packed state is set to satisfy C≥B, and a relationship between the second offset amount C and a second compressed amount B by which the second elastic member is compressed by the first packaging member from the non-packed state is set to satisfy C≥B.

6. The bearing package according to claim 1, further comprising a second packaging member enclosing the rolling bearing in the second packaging member,
wherein the second packaging member includes recessed portions recessed, between the inner ring and the outer ring, toward an interior of the rolling bearing until the second packaging member comes into contact with the rolling elements, and
wherein the first elastic member and the second elastic member are disposed between the first packaging member and the respective recessed portions of the second packaging member.

7. The bearing package according to claim 1, further comprising a cage keeping circumferential distances between the at least one row of rolling elements,
wherein the at least one row of rolling elements comprise a first row of rolling elements disposed on a first axial side of first and second opposite axial sides of the cage, the first and second opposite axial sides of the cage corresponding, respectively, to sides in the first and second axial directions, and a second row of rolling elements disposed on a second axial side of the first and second opposite axial sides of the cage, and
wherein the first elastic member and the second elastic member are pushed by the first packaging member, and press, respectively, the first row of rolling elements and the second row of rolling elements against the cage.

8. The bearing package according to claim 7, wherein the rolling bearing is a self-aligning roller bearing.

9. The bearing package according to claim 6, wherein the inner ring has:
a first end surface and a second end surface which define a width of the inner ring;
a first outer peripheral end portion located on the first axial side of the at least one row of rolling elements; and
a second outer peripheral end portion located on the second axial side of the at least one row of rolling elements,
wherein the outer ring has a third end surface and a fourth end surface which define a width of the outer ring,
wherein the first elastic member is shaped to be radially supported by the first outer peripheral end portion of the inner ring, and to partially protrude beyond the first end surface of the inner ring and the third end surface of the outer ring, in the first axial direction, and
wherein the second elastic member is shaped to be radially supported by the second outer peripheral end portion of the inner ring, and to partially protrude beyond the second end surface of the inner ring and the fourth end surface of the outer ring, in the second axial direction.

10. The bearing package according to claim 9, wherein the rolling elements are rollers,
wherein the first outer peripheral end portion of the inner ring is a radially outer surface of a flange configured to receive the first axial side of the rolling elements, and
wherein the second outer peripheral end portion of the inner ring is a radially outer surface of a flange configured to receive the second axial side of the rolling elements.

11. The bearing package according to claim 10, wherein the first outer peripheral end portion of the inner ring has a first groove extending continuously around an entire circumference of the first outer peripheral end portion, and the first elastic member includes a radially inner portion located within the first groove, and
wherein the second outer peripheral end portion of the inner ring has a second groove extending continuously around an entire circumference of the second outer peripheral end portion, and the second elastic member includes a radially inner portion located within the second groove.

12. The bearing package according to claim 11, wherein each of the first groove and the second groove has a circular arc-shaped cross section,
wherein each of the first elastic member and the second elastic member is a circular annular member having a circular cross section, and continuously extending around an entire circumference,
wherein the first groove has a sectional radius larger than a sectional radius of the first elastic member, and the second groove has a sectional radius larger than a sectional radius of the second elastic member,
wherein, in a non-packaged state in which the radially inner portion of the first elastic member and the radially inner portion of the second elastic member are located within the first groove and the second groove, respectively, and in which the first packaging member has not yet been wrapped around the rolling bearing, a widthwise center of the first groove is axially offset from a sectional center of the first elastic member toward a widthwise center of the inner ring by a first offset amount C, and a widthwise center of the second groove is axially offset from a sectional center of the second elastic member toward the widthwise center of the inner ring by a second offset amount C, and
wherein a relationship between the first offset amount C and a first compressed amount B by which the first elastic member is compressed by the first packaging member from the non-packed state is set to satisfy C≥B, and a relationship between the second offset amount C and a second compressed amount B by which the second elastic member is compressed by the first packaging member from the non-packed state is set to satisfy C≥B.

13. The bearing package according to claim 7, wherein the inner ring has:
a first end surface and a second end surface which define a width of the inner ring;
a first outer peripheral end portion located on the first axial side of the at least one row of rolling elements; and
a second outer peripheral end portion located on the second axial side of the at least one row of rolling elements,
wherein the outer ring has a third end surface and a fourth end surface which define a width of the outer ring,
wherein the first elastic member is shaped to be radially supported by the first outer peripheral end portion of the inner ring, and to partially protrude beyond the first end surface of the inner ring and the third end surface of the outer ring, in the first axial direction,
wherein the second elastic member is shaped to be radially supported by the second outer peripheral end portion of the inner ring, and to partially protrude beyond the second end surface of the inner ring and the fourth end surface of the outer ring, in the second axial direction,
wherein the rolling elements are rollers,
wherein the first outer peripheral end portion of the inner ring is a radially outer surface of a flange configured to receive the first axial side of the rolling elements,
wherein the second outer peripheral end portion of the inner ring is a radially outer surface of a flange configured to receive the second axial side of the rolling elements,
wherein the first outer peripheral end portion of the inner ring has a first groove extending continuously around an entire circumference of the first outer peripheral end portion, and the first elastic member includes a radially inner portion located within the first groove, and
wherein the second outer peripheral end portion of the inner ring has a second groove extending continuously around an entire circumference of the second outer peripheral end portion, and the second elastic member includes a radially inner portion located within the second groove.

14. The bearing package according to claim 13, wherein each of the first groove and the second groove has a circular arc-shaped cross section,
wherein each of the first elastic member and the second elastic member is a circular annular member having a circular cross section, and continuously extending around an entire circumference,
wherein the first groove has a sectional radius larger than a sectional radius of the first elastic member, and the second groove has a sectional radius larger than a sectional radius of the second elastic member,
wherein, in a non-packaged state in which the radially inner portion of the first elastic member and the radially inner portion of the second elastic member are located within the first groove and the second groove, respectively, and in which the first packaging member has not yet been wrapped around the rolling bearing, a widthwise center of the first groove is axially offset from a sectional center of the first elastic member toward a widthwise center of the inner ring by a first offset amount C, and a widthwise center of the second groove is axially offset from a sectional center of the second elastic member toward the widthwise center of the inner ring by a second offset amount C, and
wherein a relationship between the first offset amount C and a first compressed amount B by which the first elastic member is compressed by the first packaging member from the non-packed state is set to satisfy C≥B, and a relationship between the second offset amount C and a second compressed amount B by which the second elastic member is compressed by the first packaging member from the non-packed state is set to satisfy C≥B.

15. The bearing package according to claim 7, further comprising a second packaging member enclosing the rolling bearing in the second packaging member,
wherein the second packaging member includes recessed portions recessed, between the inner ring and the outer ring, toward an interior of the rolling bearing until the second packaging member comes into contact with the rolling elements, and
wherein the first elastic member and the second elastic member are disposed between the first packaging member and the respective recessed portions of the second packaging member.

16. The bearing package according to claim 15, wherein the inner ring has:
a first end surface and a second end surface which define a width of the inner ring;
a first outer peripheral end portion located on the first axial side of the at least one row of rolling elements; and
a second outer peripheral end portion located on the second axial side of the at least one row of rolling elements,
wherein the outer ring has a third end surface and a fourth end surface which define a width of the outer ring,
wherein the first elastic member is shaped to be radially supported by the first outer peripheral end portion of the inner ring, and to partially protrude beyond the first end surface of the inner ring and the third end surface of the outer ring, in the first axial direction, and
wherein the second elastic member is shaped to be radially supported by the second outer peripheral end portion of the inner ring, and to partially protrude beyond the second end surface of the inner ring and the fourth end surface of the outer ring, in the second axial direction.

17. The bearing package according to claim 16, wherein the rolling elements are rollers,
wherein the first outer peripheral end portion of the inner ring is a radially outer surface of a flange configured to receive the first axial side of the rolling elements, and
wherein the second outer peripheral end portion of the inner ring is a radially outer surface of a flange configured to receive the second axial side of the rolling elements.

18. The bearing package according to claim 17, wherein the first outer peripheral end portion of the inner ring has a first groove extending continuously around an entire circumference of the first outer peripheral end portion, and the first elastic member includes a radially inner portion located within the first groove, and
wherein the second outer peripheral end portion of the inner ring has a second groove extending continuously around an entire circumference of the second outer peripheral end portion, and the second elastic member includes a radially inner portion located within the second groove.

19. The bearing package according to claim 18, wherein each of the first groove and the second groove has a circular arc-shaped cross section,
wherein each of the first elastic member and the second elastic member is a circular annular member having a circular cross section, and continuously extending around an entire circumference,
wherein the first groove has a sectional radius larger than a sectional radius of the first elastic member, and the second groove has a sectional radius larger than a sectional radius of the second elastic member,
wherein, in a non-packaged state in which the radially inner portion of the first elastic member and the radially inner portion of the second elastic member are located within the first groove and the second groove, respectively, and in which the first packaging member has not yet been wrapped around the rolling bearing, a widthwise center of the first groove is axially offset from a sectional center of the first elastic member toward a widthwise center of the inner ring by a first offset amount C, and a widthwise center of the second groove is axially offset from a sectional center of the second elastic member toward the widthwise center of the inner ring by a second offset amount C, and
wherein a relationship between the first offset amount C and a first compressed amount B by which the first elastic member is compressed by the first packaging member from the non-packed state is set to satisfy C≥B, and a relationship between the second offset amount C and a second compressed amount B by which the second elastic member is compressed by the first packaging member from the non-packed state is set to satisfy C≥B.

20. The bearing package according to claim 13, wherein the rolling bearing is a self-aligning roller bearing.

21. The bearing package according to claim 15, wherein the rolling bearing is a self-aligning roller bearing.
